(19) United States
(12) Patent Application Publication
(10) Pub. No.: US 2015/0351181 A1
(43) Pub. Date: Dec. 3, 2015

(54) DRIVE CIRCUIT DEVICE FOR FLICKER-FREE LED

(71) Applicant: ARCADIE TECHNOLOGY CO., LTD., TAICHUNG CITY (TW)

(72) Inventors: TAI-HSIANG HUANG, TAINAN CITY (TW); KUAN-HSIANG HUANG, TAINAN CITY (TW)

(73) Assignee: ARCADIE TECHNOLOGY CO., LTD., TAICHUNG CITY (TW)

(21) Appl. No.: 14/291,267

(22) Filed: May 30, 2014

(51) Int. Cl. H05B 33/08

(52) U.S. Cl. CPC H05B 33/0821; H05B 33/0809

(57) ABSTRACT

A drive circuit device for a flicker-free LED is revealed. It comprises a drive circuit having a rectifier connecting to an AC power supply and to a plurality of LEDs in series, wherein each of the plurality of LEDs is disposed in parallel with a multilayer capacitor.

### BACKGROUND OF THE INVENTION

1. Field of the Invention

The present invention relates to a drive circuit device for a flicker-free LED. It can withstand large temperature changes and has a low production cost, high reliability, high stability and a high power factor, so as to reduce the burden on users and increase efficiency in use.

2. Description of Related Art

Light-Emitting Diodes (LEDs) have many advantages including low energy consumption, small size, long lifetime, high reaction rate, shock resistance, and monochromaticity. Therefore, LEDs have been widely accepted and used by all walks of life for lighting purposes, and many manufacturers began endeavoring to do various development and improvement of LEDs. In use of LEDs light for illumination, some factors are needed to be considered, including cost, reliability, stability and power factor. Moreover, a DC converter is also required for converting AC power into DC power to drive the LEDs, but the conversion of a voltage causes a pulsating current which make the LED current unstable and produce flicker. Accordingly, an integrated circuit (IC) is utilized to provide a constant current for solving such a problem. However, a high cost is still existed in manufacturing LED lights with IC to meet the high reliability, high stability and a high power factor.

Some manufacturers use a rectifier in parallel with a resistance and capacitance step-down capacitor for driving LEDs so as to decrease the occurrence of flicker. For instance, a schematic diagram showing a traditional circuit is revealed in FIG. 2. A drive circuit (2) comprises a rectifier (22) connecting to an AC power supply (21) and to a step-down capacitor (23) in parallel, wherein a plurality of LEDs connects to the step-down capacitor (23) in series, allowing the rectifier (22) and the step-down capacitor (23) to rectify and reduce supply mains from the AC power supply (21) for driving LEDs (24) to emit light.

Although aforementioned structure has a rectifier in series with a step-down capacitor for driving LEDs to solve a problem of flicker, it also has some disadvantages as followings:
1. The step-down capacitor is made of a high voltage electrolytic capacitor, resulting in a high cost in manufacturing an overall circuit.
2. The step-down capacitor made of a high voltage electrolytic capacitor can hardly withstand a high temperature caused by LEDs and a temperature lower than −20 degrees.
3. The step-down capacitor made of a high voltage electrolytic capacitor only has a power factor of about 50%, which is not suitable for products in need of a higher power factor.

### SUMMARY OF THE INVENTION

In view of the above-mentioned problems, the object of the present invention is to provide a drive circuit device for a flicker-free LED. It can withstand large temperature changes and has a low production cost, high reliability, high stability and a high power factor, so as to reduce the burden on users and increase efficiency in use.

Disclosed herein is a drive circuit device for a flicker-free LED, comprising a drive circuit having a rectifier connecting to an AC power supply and to a plurality of LEDs in series, wherein each of the plurality of LEDs is disposed in parallel with a multilayer capacitor.

### BRIEF DESCRIPTION OF THE DRAWINGS

FIG. 1 is a schematic diagram showing a circuit according to the present invention;

FIG. 2 is a schematic diagram showing a traditional circuit.

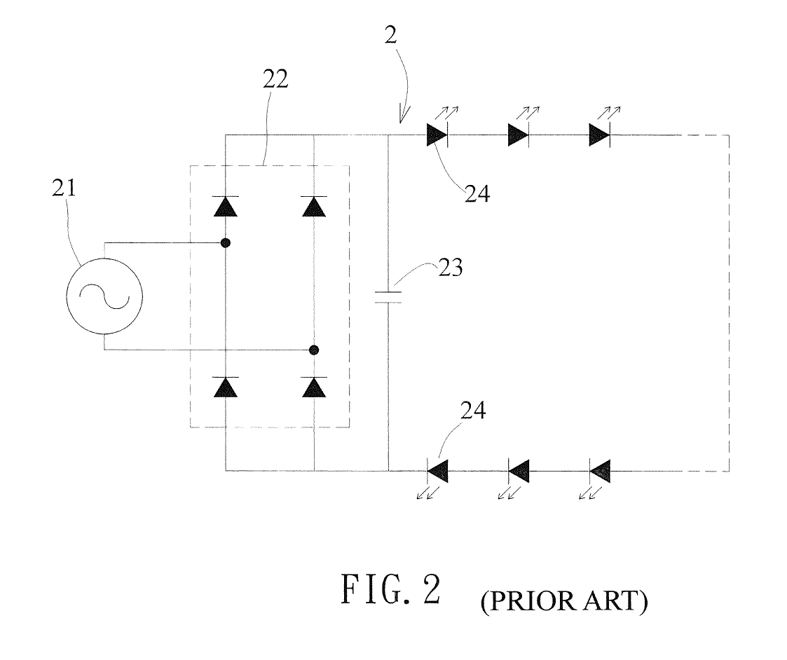

### DETAILED DESCRIPTION OF THE PREFERRED EMBODIMENT

Hereinafter, an exemplary embodiment of the present invention will be described in detail with reference to the accompanying drawings.

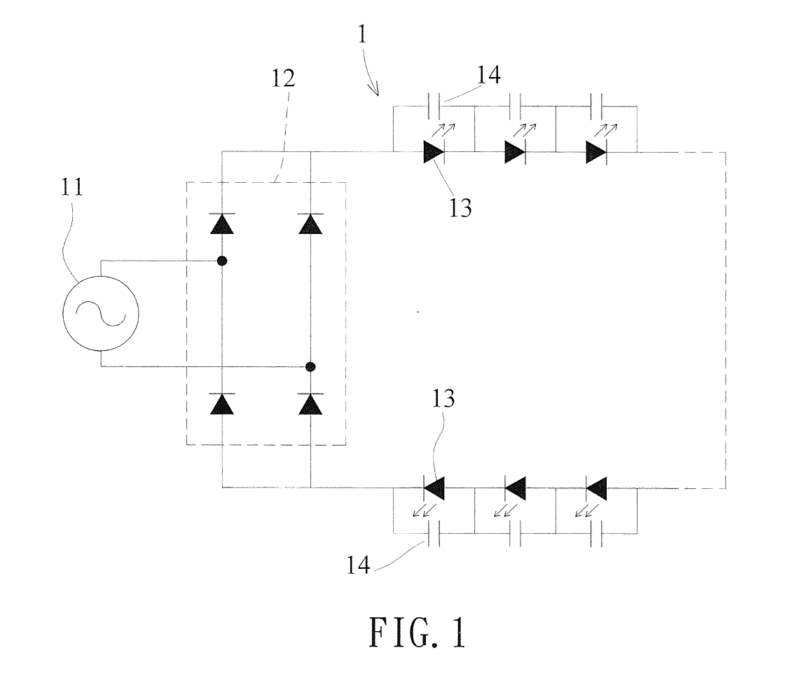

First, referring to FIG. 1, a schematic diagram showing a circuit according to the present invention is revealed. A drive circuit device for a flicker-free LED, comprising a drive circuit (1) having a rectifier (12) connecting to an AC power supply (11) and to a plurality of LEDs (13) in series, wherein each of the plurality of LEDs (13) is disposed in parallel with a multilayer capacitor (14).

Accordingly, an input of supply mains from the AC power supply (11) of the drive circuit (1) into the rectifier (12) is rectified, and then the rectified supply mains is transmitted to the plurality of LEDs (13) and the multilayer capacitor (14). The multilayer capacitor (14) further filters the rectified supply mains for supplying the plurality of LEDs (13), allowing the plurality of LEDs (13) to emit light.

According to the above description, in comparison with the traditional technique, a drive circuit device according to the present invention has the advantages as following:
1. A capacitor of the present invention made of a multilayer capacitor can lower a production cost and reduce the economic burden on users.
2. The capacitor of the present invention made of a multilayer capacitor and disposed in parallel with the plurality of LEDs can withstand large temperature changes.
3. The capacitor of the present invention made of a multilayer capacitor and disposed in parallel with the plurality of LEDs has a power factor of about 70%, resulting in high reliability, high stability and a high power factor in use of LEDs for illumination.

What is claimed is:

1. A drive circuit device for a flicker-free LED, comprising a drive circuit having a rectifier connecting to an AC power supply and to a plurality of LEDs in series, wherein each of the plurality of LEDs is disposed in parallel with a multilayer capacitor.
